(19) United States
(12) Patent Application Publication
(10) Pub. No.: US 2025/0075651 A1
(43) Pub. Date: Mar. 6, 2025

(54) AN INDEPENDENT COOLING STRUCTURE FOR VIBRATION DAMPING MUFFLER OF GENERATOR SETS

(71) Applicant: Yangzhou Etepor Power Technology Co., Ltd., Yangzhou, Jiangsu (CN)

(72) Inventors: Jinbao CHEN, Yangzhou, Jiangsu (CN); Junjie DAI, Yangzhou, Jiangsu (CN)

(21) Appl. No.: 18/288,719

(22) PCT Filed: Jul. 15, 2022
(86) PCT No.: PCT/CN2022/105884

§ 371 Date: Oct. 27, 2023

(30) Foreign Application Priority Data
Jun. 21, 2022 (CN) 202210704252.7

(51) Int. Cl. F01N 13/08; F01P 5/04; F02B 63/04; F02B 77/13; F16F 15/08

(52) U.S. Cl. CPC F01N 13/08; F01P 5/04; F02B 63/04; F02B 77/13; F16F 15/08

(57) ABSTRACT

An independent cooling structure for vibration damping muffler of generator sets, comprising a base, a soundproof cover, a baffle plate, a generator cooling air duct, an engine, a generator body, a cooling air duct for exhaust pipe of cylinder head, a muffler, a flexible hose for damping vibration and an exhaust pipe of cylinder head. The cooling air duct for exhaust pipe of cylinder head is arranged on the side of the generator cooling air duct. The cooling air duct for exhaust pipe of cylinder head is connected with the engine recoil starter. The exhaust pipe of cylinder head is arranged on the cylinder head of the engine. The exhaust pipe of cylinder head is located in the cooling air duct for exhaust pipe of cylinder head. The muffler is arranged in the cooling and heat-discharging cavity of the muffler. An exhaust pipe is arranged on the bottom of the muffler.

### 1. TECHNICAL FIELD

The invention relates to the field of muffler cooling technology, in particular to an independent cooling structure for vibration damping muffler of generator sets.

### 2. BACKGROUND ART

Working noise and exhaust noise are the most important noise sources of the engine. In order to reduce the noise during the working process of the engine, the engine is usually equipped with a muffler. The traditional muffler is directly fixed on the generator, which is prone to vibrate when the generator set is working, thereby causing vibration damage to the muffler. In addition, when the muffler reduces the vibration and noise of the engine cylinder head, the overall temperature of the muffler will rise, so it is necessary to set up a cooling mechanism for the muffler. The existing cooling system for the muffler is usually used in combination with the cooling system for the generator set. The muffler is cooled by the heat dissipation air flow of the generator. Although this structure can cool of the muffler, because the overall temperature of the muffler is much higher than that of the heat dissipation airflow discharged from the generator set, the high temperature of the muffler will be fed back to the heat dissipation channel of the generator set, causing the ambient temperature inside the heat dissipation channel of the generator set to increase, eventually resulting in poor heat dissipation of the generator set.

### 3. SUMMARY OF THE INVENTION

In view of the above situation, in order to make up for the above existing defects, the invention provides an independent cooling structure for vibration damping muffler of generator sets with excellent vibration damping function and cooling performance, which is a separate structure from the heat dissipation and cooling system of the generator.

The invention provides the following technical scheme: an independent cooling structure for vibration damping muffler of generator sets, comprising a base, a soundproof cover, a baffle plate, a generator cooling air duct, an engine, a generator body, a cooling air duct for exhaust pipe of cylinder head, a muffler, a flexible hose for damping vibration and an exhaust pipe of cylinder head. The soundproof cover is arranged at one end of the base. The baffle plate is arranged inside the soundproof cover. The baffle plate divides the soundproof cover into a cooling and heat-discharging cavity of the generator and a cooling and heat-discharging cavity of the muffler. The generator cooling air duct is fixed on the base. The engine is arranged on the base. The engine is located on one side of the generator cooling air duct. The side of the generator cooling air duct closer to the engine is a non-closed structure. The output shaft of the engine extends into the generator cooling air duct. The side of the engine farther away from the generator cooling air duct is provided with an engine recoil starter. The engine recoil starter is provided with an air inlet. The base is provided with air inlet slot. The air inlet slot is located below the engine. The generator body includes a generator rotor and a generator stator. The generator rotor is connected to the output shaft of the engine. The generator rotor is equipped with a reverse suction fan. The cooling air duct for exhaust pipe of cylinder head is arranged on the side of the generator cooling air duct. The cooling air duct for exhaust pipe of cylinder head is connected with the engine recoil starter. The exhaust pipe of cylinder head is arranged on the cylinder head of the engine. The exhaust pipe of cylinder head is located in the cooling air duct for exhaust pipe of cylinder head. The cooling air duct for exhaust pipe of cylinder head is connected to the soundproof cover. The exhaust pipe of cylinder head extends into the cooling and heat-discharging cavity of the muffler of soundproof cover. The muffler is arranged in the cooling and heat-discharging cavity of the muffler. An exhaust pipe is arranged on the bottom of the muffler. The base is provided with exhaust slot. The exhaust pipe extends into the exhaust slot. An air inlet pipe is arranged on the muffler. The flexible hose for damping vibration is arranged between the exhaust pipe of cylinder head and the air inlet pipe of the muffler. Under the action of the flexible hose for damping vibration, part of vibration and noise can be reduced. Under the action of the reverse suction fan, on the one hand, the external low-temperature air enters the cooling air duct for exhaust pipe of cylinder head and the generator cooling air duct through the air inlet of the engine recoil starter, the cooling air duct for exhaust pipe of cylinder head and the generator cooling air duct respectively form air guiding channels to ensure that the low-temperature airflows flow along the air guiding channels. A small part of the low-temperature air enters the generator cooling air duct to form a low-temperature airflow for cooling the generator body, while most of the low-temperature air enters the cooling air duct for exhaust pipe of cylinder head to form a low-temperature airflow blowing toward the cylinder head, exhaust pipe of cylinder head and muffler, thereby cooling the cylinder head, exhaust pipe of cylinder head and muffler, and finally discharged through the exhaust slot. On the other hand, the external low-temperature air enters the generator cooling air duct through the air inlet slot of the base, and supplements the low-temperature air entering from the air inlet of the engine recoil starter to further improve the cooling effect on the engine and the generator body.

Preferably, the base is provided with four sets of rubber vibration dampers. The four sets of rubber vibration dampers are respectively arranged at four corners below the muffler.

Preferably, the baffle plate is a heat insulation board, which prevents the heat in the cooling and heat-discharging cavity of the muffler from affecting the temperature in the cooling and heat-discharging cavity of the generator.

By adopting the above structure, the invention obtains the following advantageous effects: the invention provides an independent cooling structure for vibration damping muffler of generator sets. By setting up the soundproof cover and its internal baffle plate, the heat dissipation and cooling areas of the generator and muffler are separated to avoid the adverse effects of high temperature on the generator caused by the muffler. Through the setting of the cooling and heat-discharging cavity of the muffler, an independent placement interspace is provided for the muffler, solving the problem of vibration damage caused by directly placing the muffler on the generator. With the cooperation of the flexible hose for damping vibration and rubber vibration dampers, the muffler achieves the function of vibration reduction and noise reduction. Meanwhile, through the setting of the air inlet of engine recoil starter and air inlet slot of the base, under the negative pressure generated by the reverse suction fan during rotation, low-temperature air is brought into the cooling air duct of the exhaust pipe of cylinder head and the generator cooling air duct through the air inlet of engine recoil starter and air inlet slot of the base. Therefore, the exhaust pipe of cylinder head, muffler, and generator body can be efficiently cooled respectively, thereby improving the overall cooling efficiency.

### 4. BRIEF DESCRIPTION OF ACCOMPANY DRAWINGS

The accompanying drawings are used to provide a further understanding of the invention, and constitute a part of the specification, together with the embodiments of the invention, are used to explain the invention, and do not constitute a limitation to the invention. In the accompanying drawings:

FIG. 1 is a schematic diagram of overall position and structure of the engine of an independent cooling structure for vibration damping muffler of generator sets proposed by the invention.

FIG. 2 is a schematic diagram of the positions of the cooling air duct for exhaust pipe of cylinder head and the exhaust pipe of cylinder head in an independent cooling structure for vibration damping muffler of generator sets proposed by the invention.

FIG. 3 is a schematic diagram 1 of the internal structure of a soundproof cover of an independent cooling structure for vibration damping muffler of generator sets proposed by the invention.

FIG. 4 is a schematic diagram 2 of the internal structure of a soundproof cover of an independent cooling structure for vibration damping muffler of generator sets proposed by the invention.

FIG. 5 is a schematic diagram of the bottom structure of an independent cooling structure for vibration damping muffler of generator sets proposed by the invention.

As shown in the accompanying drawings: 1 base, 2 soundproof cover, 3 baffle plate, 4 generator cooling air duct, 5 engine, 6 cooling air duct for exhaust pipe of cylinder head, 7 muffler, 8 flexible hose for damping vibration, 9 exhaust pipe of cylinder head, 10 cooling and heat-discharging cavity of the generator, 11 cooling and heat-discharging cavity of the muffler, 12 engine recoil starter, 13 air inlet, 14 air inlet slot, 15 reverse suction fan, 16 exhaust pipe, 17 exhaust slot, 18 air inlet pipe, 19 rubber vibration damper.

### 5. SPECIFIC EMBODIMENT OF THE INVENTION

The following will clearly and completely describe the technical schemes in the embodiments of the invention in combination with the accompanying drawings in the embodiments of the invention. Obviously, the accompanying drawings in the following description are only some embodiments of the invention, but not all embodiments. Based on the embodiments of the invention, all other embodiments obtained by those of ordinary skill in the art without making creative efforts belong to the protection scope of the invention.

It should be noted that the words “front”, “rear”, “left”, “right”, “upper” and “lower” used in the following description refer to the directions in the accompanying drawings. The words “inner” and “outer” refer to directions toward or away from the geometric center of a particular part respectively.

As shown in FIG. 1, an independent cooling structure for vibration damping muffler of generator sets provided by the invention is located at the position of the ellipse in FIG. 1 (the overall structure of the engine).

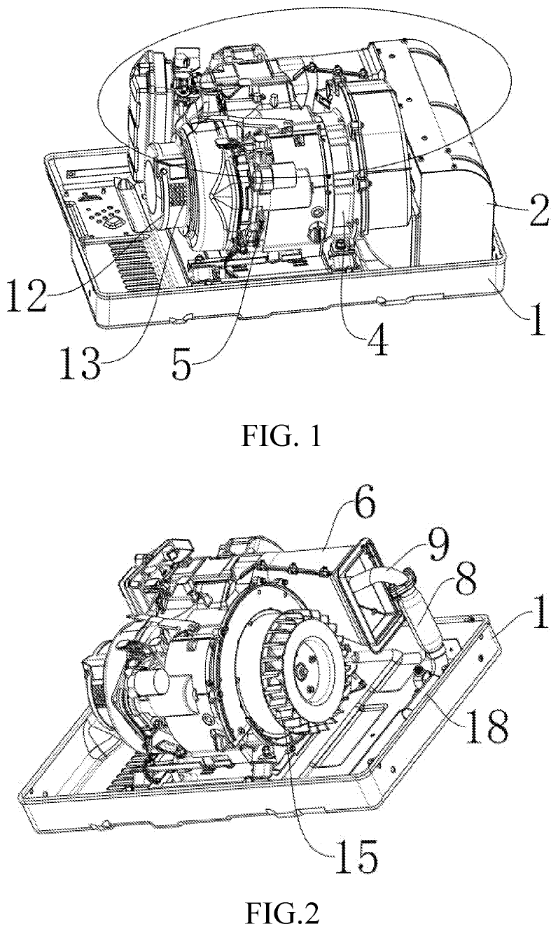

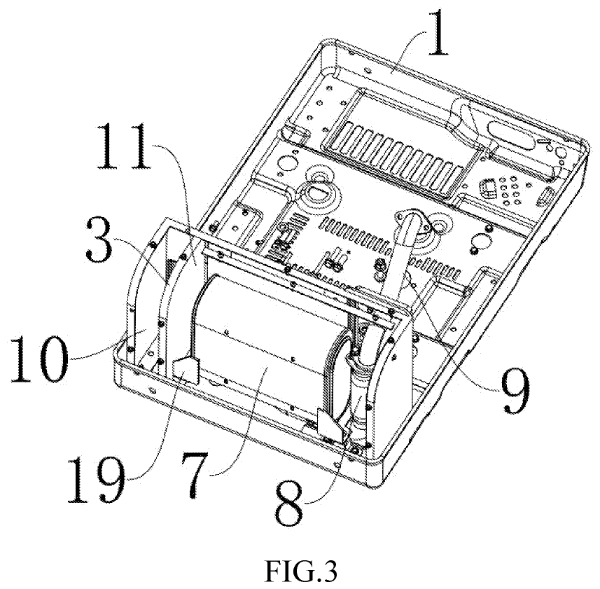

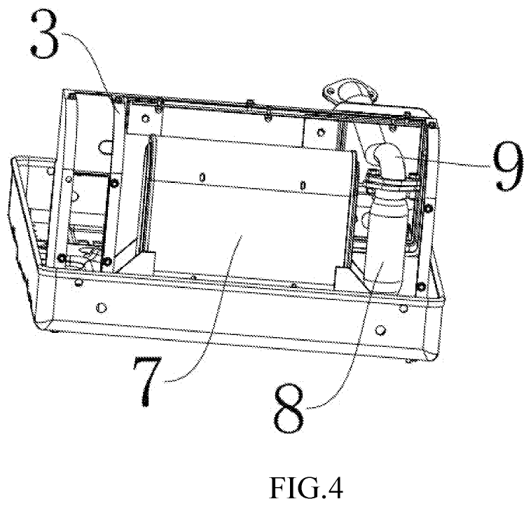

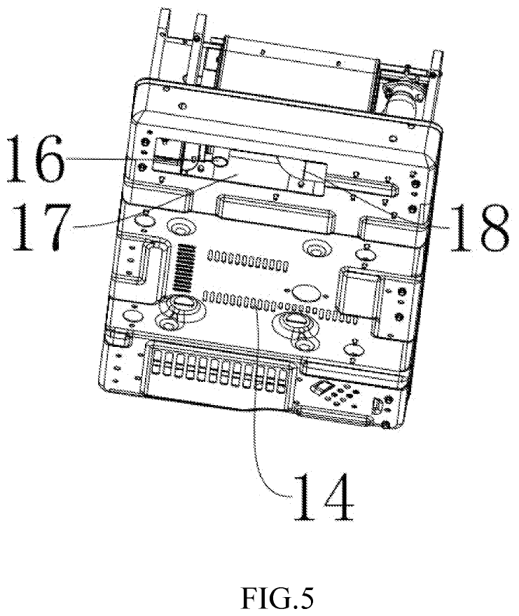

As shown in FIG. 2, FIG. 3, FIG. 4, FIG. 5, the invention adopts the following technical scheme: an independent cooling structure for vibration damping muffler of generator sets, comprising a base 1, a soundproof cover 2, a baffle plate 3, a generator cooling air duct 4, an engine 5, a generator body, a cooling air duct for exhaust pipe of cylinder head 6, a muffler 7, a flexible hose for damping vibration 8 and an exhaust pipe of cylinder head 9. The soundproof cover 2 is arranged at one end of the base 1. The baffle plate 3 is arranged inside the soundproof cover 2. The baffle plate 3 divides the soundproof cover 2 into a cooling and heat-discharging cavity of the generator 10 and a cooling and heat-discharging cavity of the muffler 11. The generator cooling air duct 4 is fixed on the base 1. The engine 5 is arranged on the base 1. The engine 5 is located on one side of the generator cooling air duct 4. The side of the generator cooling air duct 4 closer to the engine 5 is a non-closed structure. The output shaft of the engine 5 extends into the generator cooling air duct 4. The side of the engine 5 farther away from the generator cooling air duct 4 is provided with an engine recoil starter 12. The engine recoil starter 12 is provided with an air inlet 13. The base 1 is provided with air inlet slot 14. The air inlet slot 14 is located below the engine 5. The generator body includes a generator rotor and a generator stator. The generator rotor is connected to the output shaft of the engine 5. The generator rotor is equipped with a reverse suction fan 15. The cooling air duct for exhaust pipe of cylinder head 6 is arranged on the side of the generator cooling air duct 4. The cooling air duct for exhaust pipe of cylinder head 6 is connected with the engine recoil starter 12. The exhaust pipe of cylinder head 9 is arranged on the cylinder head of the engine. The exhaust pipe of cylinder head 9 is located in the cooling air duct for exhaust pipe of cylinder head 6. The cooling air duct for exhaust pipe of cylinder head 6 is connected to the soundproof cover 2. The exhaust pipe of cylinder head 9 extends into the cooling and heat-discharging cavity of the muffler 11 of soundproof cover 2. The muffler 7 is arranged in the cooling and heat-discharging cavity of the muffler 11. An exhaust pipe 16 is arranged on the bottom of the muffler 7. The base 1 is provided with exhaust slot 17. The exhaust pipe 16 extends into the exhaust slot 17. An air inlet pipe 18 is arranged on the muffler 7. The flexible hose for damping vibration 8 is arranged between the exhaust pipe of cylinder head 9 and the air inlet pipe 18 of the muffler 7.

Wherein, the base 1 is provided with four sets of rubber vibration dampers 19. The four sets of rubber vibration dampers 19 are respectively arranged at four corners below the muffler 7. The baffle plate 3 is a heat insulation board, which prevents the high temperature in the cooling and heat-discharging cavity of the muffler 11 from affecting the temperature in the cooling and heat-discharging cavity of the generator 10.

During the practical use, the invention provides an independent cooling structure for vibration damping muffler of generator sets. By setting up the soundproof cover 2 and its internal baffle plate 3, the heat dissipation and cooling areas of the generator and muffler 7 are separated to avoid the adverse effects of high temperature on the generator caused by the muffler 7. Through the setting of the cooling and heat-discharging cavity of the muffler 11, an independent placement interspace is provided for the muffler 7, solving the problem of vibration damage caused by directly placing the muffler on the generator. With the cooperation of the flexible hose for damping vibration 8 and rubber vibration dampers 19, the muffler 7 achieves the function of vibration reduction and noise reduction. Meanwhile, under the action of the reverse suction fan 15, on the one hand, the external low-temperature air enters the generator cooling air duct 4 and the cooling air duct for exhaust pipe of cylinder head 6 through the air inlet 13 of the engine recoil starter 12. The generator cooling air duct 4 and the cooling air duct for exhaust pipe of cylinder head 6 respectively form air guiding channels to ensure that the low-temperature airflows flow along the air guiding channels. A small part of the low-temperature air enters the generator cooling air duct 4 to form a low-temperature airflow for cooling the generator body 5, while most of the low-temperature air enters the cooling air duct for exhaust pipe of cylinder head 6 to form a low-temperature airflow blowing toward the cylinder head, exhaust pipe of cylinder head 9 and muffler 7, thereby cooling the cylinder head, exhaust pipe of cylinder head 9 and muffler 7, and finally discharged through the exhaust slot 17. On the other hand, the external low-temperature air enters the generator cooling air duct 4 through the air inlet slot 14 of the base 1, and supplements the low-temperature air entering from the air inlet 13 of the engine recoil starter 12 to further improve the cooling effect on the engine and the generator body 5.

It should be noted that in the embodiments of the invention, relational terms such as first and second are only used to distinguish one entity or operation from another entity or operation, and do not necessarily require or imply that there is any such actual relationship or order between these entities or operations. Furthermore, the terms “comprise”, “include” or any other variation thereof are intended to encompass non exclusive inclusion, such that a process, method, material, or equipment that includes a series of elements not only includes those elements, but also other elements that are not clearly listed, or also includes the elements inherent in such a process, method, material, or equipment.

Although the embodiments of the invention have been shown and described, those skilled in the art can understand that various changes, modifications and substitutions can be made to these embodiments without departing from the principle and spirit of the invention. Therefore, the protection scope of the invention should be subject to the protection scope defined by the claims and equivalents thereof.

1. An independent cooling structure for vibration damping muffler of generator sets, comprising a base (1), a soundproof cover (2), a baffle plate (3), a generator cooling air duct (4), an engine (5), a generator body, a cooling air duct for exhaust pipe of cylinder head (6), a muffler (7), a flexible hose for damping vibration (8) and an exhaust pipe of cylinder head (9). The soundproof cover (2) is arranged at one end of the base (1). The baffle plate (3) is arranged inside the soundproof cover (2). The baffle plate (3) divides the soundproof cover (2) into a cooling and heat-discharging cavity of the generator (10) and a cooling and heat-discharging cavity of the muffler (11). The generator cooling air duct (4) is fixed on the base (1). The engine (5) is arranged on the base (1). The engine (5) is located on one side of the generator cooling air duct (4). The side of the generator cooling air duct (4) closer to the engine (5) is a non-closed structure. The output shaft of the engine (5) extends into the generator cooling air duct (4). The side of the engine (5) farther away from the generator cooling air duct (4) is provided with an engine recoil starter (12). The engine recoil starter (12) is provided with an air inlet (13). The base (1) is provided with air inlet slot (14). The air inlet slot (14) is located below the engine (5). The generator body includes a generator rotor and a generator stator. The generator rotor is connected to the output shaft of the engine (5). The generator rotor is equipped with a reverse suction fan (15). The cooling air duct for exhaust pipe of cylinder head (6) is arranged on the side of the generator cooling air duct (4). The cooling air duct for exhaust pipe of cylinder head (6) is connected with the engine recoil starter (12). The exhaust pipe of cylinder head (9) is arranged on the cylinder head of the engine. The exhaust pipe of cylinder head (9) is located in the cooling air duct for exhaust pipe of cylinder head (6). The cooling air duct for exhaust pipe of cylinder head (6) is connected to the soundproof cover (2). The exhaust pipe of cylinder head (9) extends into the cooling and heat-discharging cavity of the muffler (11) of soundproof cover (2). The muffler (7) is arranged in the cooling and heat-discharging cavity of the muffler (11). An exhaust pipe (16) is arranged on the bottom of the muffler (7). The base (1) is provided with exhaust slot (17). The exhaust pipe (16) extends into the exhaust slot (17). An air inlet pipe (18) is arranged on the muffler (7). The flexible hose for damping vibration (8) is arranged between the exhaust pipe of cylinder head (9) and the air inlet pipe (18) of the muffler (7).

2. The independent cooling structure for vibration damping muffler of generator sets of claim 1, the base (1) is provided with four sets of rubber vibration dampers (19). The four sets of rubber vibration dampers (19) are respectively arranged at four corners below the muffler (7).

3. The independent cooling structure for vibration damping muffler of generator sets of claim 1, the baffle plate (3) is a heat insulation board.
